(19) United States
(12) Patent Application Publication
(10) Pub. No.: US 2003/0124314 A1
(43) Pub. Date: Jul. 3, 2003

(54) Structurally enhanced sound and heat energy absorbing liner and related method

(76) Inventors: Rajendran S. Michael, Granville, OH (US); Galen R. Dudgeon, Newark, OH (US); Dale A. Grove, Pataskala, OH (US)

Correspondence Address: OWENS CORNING, 2790 COLUMBUS ROAD, GRANVILLE, OH, 43023, US

(21) Appl. No.: 10/038,968

(22) Filed: Dec. 31, 2001

(51) Int. Cl. B32B 1/00; D06N 7/04; B32B 3/00; D04H 1/00

(52) U.S. Cl. 428/156; 428/141; 428/172

(57) ABSTRACT

A liner for insulating against the transmission of sound and heat energy, such as from the engine compartment of a vehicle, is disclosed. The liner is formed of an insulating layer or core and first and second structural layers. By creating regions or areas of the liner that are selectively lofted or compressed, the attenuation of undesirable sound energy and absorption of heat energy can be balanced with the desired degree of structural enhancement to be afforded for a particular application.

### TECHNICAL FIELD AND INDUSTRIAL APPLICABILITY OF THE INVENTION

The present invention relates generally to a structurally enhanced, multi-layer, sound and heat energy absorbing liner.

### BACKGROUND OF THE INVENTION

Various types of materials have been proposed for use as insulating liners to absorb sound and heat energy. One area where insulating liners find significant utility is in vehicles, such as cars, trucks, vans, or the like. Typical uses include as a hoodliner for insulating the space above the engine compartment, a headliner for insulating the ceiling in the interior passenger compartment, or as a filler for insulating the cavities in the doors or like spaces.

In the case of a hoodliner, the conventional approach has been to use phenolic resin-impregnated glass wool or cotton shoddy layer as the hoodliner. Typically, a hoodliner formed of this material is attached directly to the contoured underside surface of the hood of the vehicle, such that it serves to insulate against both the sound and heat energy created by the engine and other components in the engine compartment. The hood itself, which is often fabricated of cold-formed steel, aluminum, a durable high-strength alloy, or a composite material, usually includes a plurality of strategically positioned reinforcing ribs that are visible only from the side facing the engine compartment when the hoodliner is removed. These ribs are designed to rigidify and structurally enhance the hood and, in conjunction with other modern design characteristics, such as deformable energy-absorbing bumpers and side panels, generally improve the overall crashworthiness of the vehicle.

While a hoodliner fabricated of such materials generally provides at least a moderate degree of sound and heat absorption and is thus acceptable for most applications, there are well-recognized limitations and shortcomings. Typically, these materials are specially coated with chemical fire retardants or the like. However, this added processing increases the manufacturing time and expense. Moreover, if the retardant is not applied properly to all surfaces of the hoodliner or in the required amounts, the desired heat resistance may not be achieved. Also, the effects of surface treatments tend to wear off and degrade the underlying material over time, which may result in a hoodliner having a dark, dingy, and aesthetically unappealing appearance.

Another limitation with this conventional approach is that the glass wool or cotton shoddy liners contribute nothing to the strength of the hood itself. While forming ribs in the hood does serve to enhance its structural rigidity, they also obviously add to the weight and overall manufacturing expense of the vehicle. A hoodliner that is sufficiently rigid to structurally enhance the hood, and hence, at least reduce the number of ribs required (and perhaps in some cases even eliminate them altogether), is thus desirable from both a cost savings and ease of manufacturing standpoint.

### SUMMARY OF THE INVENTION

Accordingly, a liner is disclosed that is capable of enhancing the strength of a structure to which it is attached or mounted, such as the hood of a vehicle. In addition to providing structural enhancement, the liner is also able to efficiently absorb sound and heat energy, as necessary or desired for a particular application. Overall, the hoodliner of the present invention is vastly stronger than those formed of phenolic-resin impregnated glass wool or cotton shoddy materials alone. In some cases, the added strength may even allow the vehicle designer to reduce or eliminate the structurally enhancing ribs typically formed in vehicle hoods, which may result in a significant weight savings.

In accordance with a first aspect of the present invention, a structurally enhanced liner for selectively insulating against the transmission of sound and heat energy is provided. It comprises a multi-layer substrate comprising an insulating layer and at least one structural layer. The structural layer comprises a reinforced composite. The substrate is formed so as to have at least one lofted area for insulating against the transmission of sound and heat energy and at least one compacted area for structurally enhancing the liner.

Preferably, the substrate comprises first and second structural layers. At least one of the structural layers may be formed from a reinforced composite comprising a non-woven mat including a plurality of chopped fibers and a polymeric material. The polymeric material preferably comprises a polyvinyl chloride. This material provides the structural layer(s) with a requisite stiffness and thermal and dimensional stability such that the liner is capable of being used in a high temperature environment, e.g., attached to a vehicle hood and positioned in the space above the engine compartment.

The insulating layer may comprise at least one of a non-woven fiber insulation layer, a phenolic-bound non-woven glass fiber mat, a polyurethane foam sheet, a needled fiber mat, and a mixture of organic and mineral fibers formed in a lofted and semi-compacted batt. The non-woven fiber insulation layer may comprise a non-woven fabric made from one or more of a polyolefin, polyester, polypropylene, rayon, aramid and cotton.

In one embodiment, the substrate may have first and second lofted areas, and a first compacted area. The first lofted area has a first thickness of a first dimension, the second lofted area has a second thickness of a second dimension and the compacted area has a third thickness of a third dimension. The second dimension is greater than the first and third dimensions and the first dimension is greater than the third dimension.

In another embodiment, the substrate has a lofted area with a first thickness of a first dimension and a compacted area with a second thickness of a second dimension. The first dimension is substantially equal to about 1 to about 50 times the second dimension.

The substrate may comprise a hoodliner.

In accordance with a second aspect of the present invention, a method is provided for manufacturing a structurally enhanced liner for selectively insulating against the transmission of ambient sound and heat energy. The process comprises the steps of: forming a multi-layer substrate comprising an insulating layer of material and first and second structural layers, each structural layer comprising a reinforced composite; and compressing one or more selected regions of the substrate to structurally enhance the liner, while leaving at least one lofted region for insulating against the transmission of sound and heat energy.

The step of compressing the one or more selected regions of the substrate may include the step of placing the substrate between a pair of opposing dies that together form a contour corresponding to the desired shape of the liner.

In one embodiment, the step of forming a multi-layer substrate may comprise the steps of: combining the insulating and first and second structural layers such that the insulating layer is positioned between the first and second structural layers; heating the combined insulating and structural layers under slight pressure such that the layers are laminated to one another to form the substrate. The step of compressing one or more selected regions of the substrate may comprise the steps of: heating the laminated substrate; placing the heated substrate between a pair of cold dies; and bringing together the dies so as to compress the one or more selected regions of the substrate.

In another embodiment of the present invention, the steps of forming a multi-layer substrate and compressing one or more selected regions of the substrate comprise the steps of: combining the insulating and first and second structural layers such that the insulating layer is positioned between the first and second structural layers; heating the combined insulating and structural layers; placing the heated layers between a pair of cold dies; and bringing together the dies so as to laminate the layers together to form the substrate while also compressing the one or more selected regions of the substrate.

### BRIEF DESCRIPTION OF THE DRAWING FIGURES

FIG. 1 is a partially cutaway side cross-sectional exploded view in elevation of one embodiment of the liner of the present invention;

FIGS. 2A and 2B are partially schematic, partially cross-sectional views of a cold molding process used to form the liner having a variable contour and degree of compaction;

FIG. 2C is a cross-sectional view of a hoodliner formed in accordance with a first embodiment of the present invention;

FIG. 3 is a plan view of the hoodliner illustrated in FIG. 2C;

FIG. 4 is a plan view of a hoodliner formed in accordance with a second embodiment of the present invention;

FIG. 5 is a view taken along view line 5-5 in FIG. 4; and

FIG. 6 is a cross-sectional view of a hoodliner formed in accordance with a third embodiment of the present invention.

### DETAILED DESCRIPTION AND PREFERRED EMBODIMENTS OF THE INVENTION

Reference is now made to FIG. 1, which illustrates a portion of a structurally enhanced multi-layer sound and heat energy absorbing liner 10 of the present invention in cross-section. The liner 10 comprises a multi-layer substrate 11 including an insulating layer or core 12 and first and second outer structural layers 14, 16.

The material used to form the core 12 is preferably made from an insulating material that is lightweight, permeable to air and capable of being compressed or compacted, such as by a conventional compression press. Examples of such materials include non-woven natural or polymer fiber insulation, one of which comprises a layer having a thickness of from about 5 mm to about 30 mm, a density of from about 200 grams/meter² to about 1000 grams/meter² is formed from polyolefin and polyester and is commercially available from 3M under the trade designation “THINSULATE.”

Another fiber insulation layer capable of being used as core 12 is a needle-punched, highloft non-woven fabric made from one or more of the following materials: polyester, polypropylene, rayon, aramid and cotton. The fiber insulation fabric has a density of from about 67 to about 510 grams/meter² and is commercially available from the Rogers Corporation. The insulating layer or core 12 may also be made from a phenolic-bound, non-woven glass fiber mat, one of which comprises glass fibers in an amount from about 50% to about 95% by weight, based on the total weight of the mat, and a phenolic binder in an amount of from about 5% to about 50% by weight, based on the total weight of the mat. The phenolic-bound, non-woven glass fiber mat preferably has a thickness of from about 5 mm to about 30 mm, a density of from about 300 to about 1000 grams/meter² and is commercially available from Owens Corning under the trade designation “Molding Media.”

The insulating layer or core 12 may additionally comprise a polyurethane foam sheet having a thickness of from about 5 mm to about 15 mm and a density of from about 2 to about 5 pounds/ft³, examples of which are commercially available from Woodbridge Foam Group under the trade designation “RT2015” or “RT2525” and Foamex International under the trade designation “Custom Fit.”

It is further contemplated that the insulating layer or core 12 may be formed from a needled polymer/natural fiber mat made, for example, from polypropylene fiber/hemp (one of which comprises 50% by weight polypropylene fibers, based on the total weight of the layer, and 50% by weight hemp, has a density of about 1500 grams/m² and is commercially available from Indiana Composites under the trade designation “Flexform”) or polypropylene fiber/jute (one of which comprises 50% by weight polypropylene fibers, based on the total weight of the layer, and 50% by weight jute, and is commercially available from Juta A. S. under the trade designation “Netex-S 250,” “Netex-S 500” or “Netex-S 750”). It is additionally contemplated that the insulating layer or core 12 may comprise a lofted or semi-compacted batt formed from a mixture of organic and mineral fibers, e.g., a polyethylene terephthalate/glass combination, one of which is commercially available from Owens Corning under the trade designation “Versamat 3000,” and is described in patent application, U.S. Ser. No. ______ (Attorney Docket No. ______-), filed on ______-by ______-, and is entitled “______-,” the disclosure of which is incorporated herein by reference. The insulating layer or core 12 may further comprise other materials that are capable of insulating against sound and heat energy (including a phenolic resin impregnated cotton shoddy layer). The particular type of insulating material chosen for forming the core 12 will generally depend on the parameters of the particular application, including the type of vehicle, the amount and degree of sound and heat that must be absorbed, and/or cost considerations.

The outer layers 14, 16 are formed from a reinforced composite comprising reinforcement fibers such as discontinuous or chopped glass and/or carbon fibers in combination with a binder or resin system. Preferably, the reinforced composite can be formed during a molding process to a predefined set shape and the resin system cured (i.e., crosslinked if a thermoset-based system) or subsequently solidified during cooling (if a thermoplastic-based system) such that a stiff skin is formed that is not reshapeable after subsequent repeated exposures to temperatures up to about 400 degrees F.

The reinforced composite may comprise a non-woven mat. Such a mat may be formed using a typical wet-forming process, where chemically sized, wet chopped glass fibers or strands (e.g., A glass, E glass, or others) are combined with an aqueous suspension of a thermoplastic, and processed into a wet-laid, sheet-like material. The glass fibers may have a diameter of from about 4 microns to about 30 microns and a length of from about 1/32 inch to about 2.0 inches. The thermoplastic is preferably a polyvinyl chloride (PVC) containing a heat stabilizer. One such heat stabilizer is commercially available from AloFina Chemicals Inc. and is sold under any one of the trade designations “Thermolite 31,” “Thermolite 108,” “Thermolite 137,” and “Thermolite 340.” The heat stabilizer may also comprise one commercially available from Rhodia Inc. under the trade designation “Rhodia Stab 50.” The heat stabilizer comprises about 1% to about 9% of the PVC/heat stabilizer material while the PVC comprises about 91% to about 99% of the PVC/heat stabilizer material. The PVC/heat stabilizer material ensures that the resulting mat used to form the layers 14 or 16, and hence, the liner 10, is capable of being repeatedly exposed to temperatures up to about 400 degrees F. without losing its dimensional stability. The thermoplastic (PVC/heat stabilizer material) is generally employed in an amount from about 20% to about 90% by weight of the solids (dry weight basis) based on the combined weight of the mat, while the chopped glass fibers are employed in an amount from about 10% to about 80% by weight of the solids. Preferably, the mat has a thickness of from about 1 mm to about 10 mm and a density of from about 500 g/m² to about 2000 grams/m². A more detailed description of the mat and a process for forming same is described in U.S. Pat. No. 6,093,359 to Gauchel et al., the disclosure of which is incorporated herein by reference.

Preferably, the outer layers 14 and 16 have a flexural modulus of between about 0.90-1.5×10⁶ psi; a flexural strength of approximately 15-35×10³ psi; and tensile strength of approximately 10-23×10³ psi.

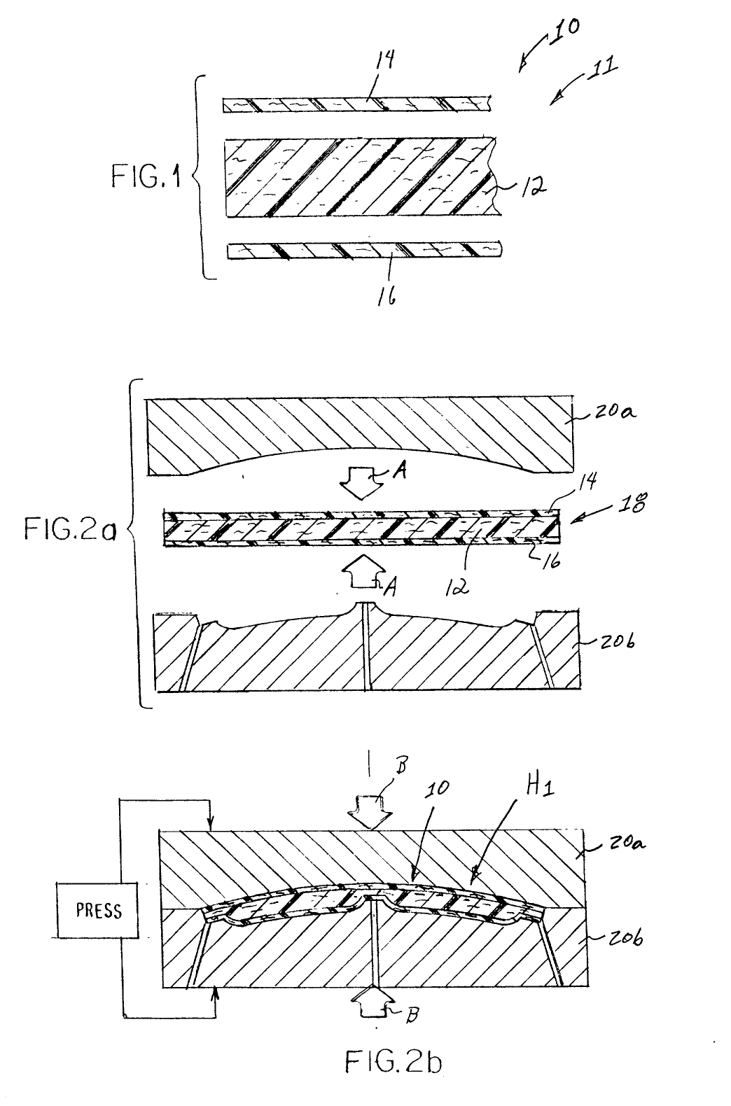

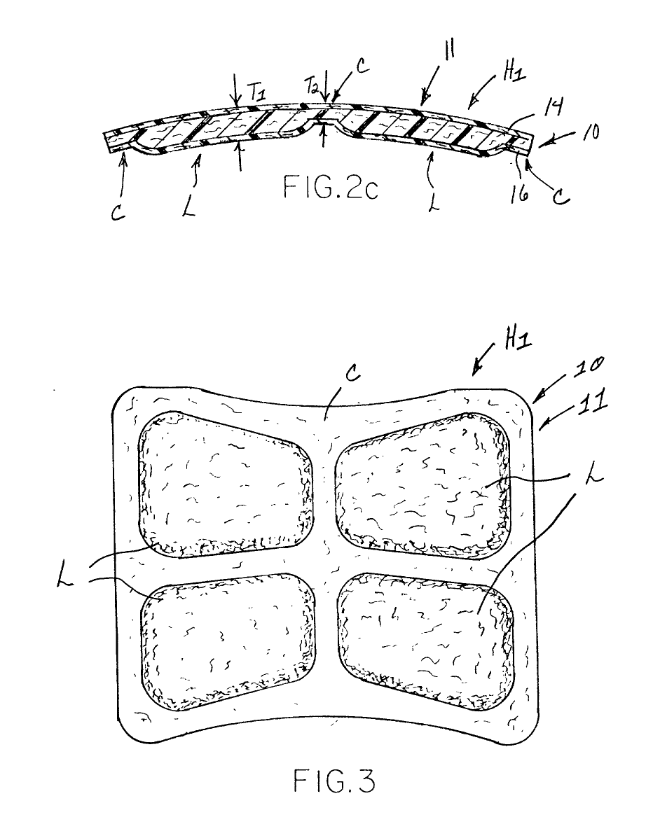

To form the composite liner 10 of the present invention, a hoodliner H₁ in the illustrated embodiment, the outer layers 14 and 16 and the core layer 12 are positioned such that the core layer 12 is located between the outer layers 14 and 16. The combined layers 12, 14, 16 are then positioned between a pair of heated belts (not shown), heated to a temperature of about 300 degrees F, and remain between the belts for approximately 60-90 seconds. In addition to applying heat to the layers 12, 14, and 16, the belts also apply a slight pressure causing the layers 12, 14 and 16 to bond or laminate to one another so as to form a laminate 18 (also referred to herein as a multi-layer substrate 11), see FIG. 2A. A separate adhesive layer at each outer layer/core layer interface is not required.

The laminate 18 is heated to temperature of about 350 degrees F. to make it soft, pliable, and susceptible to molding. This can be done by passing the laminate 18 through a warming device, such as an infrared or convection oven (not shown). The warmed laminate 18 is then placed between cold opposing dies 20a, 20b in a mold, see FIGS. 2A and 2B, or other cold shaping tool. The dies 20a, 20b are capable of moving relative to each other between open (FIG. 2A) and closed (FIG. 2B) positions (see action arrows A and B). Each mold half is connected to a hydraulic or pneumatic press or like motive device capable of moving these halves, and hence, the dies 20a, 20b towards each other.

When the dies 20a, 20b are brought together by the press, the laminate 18 is thus compressed or compacted in certain areas, yet remains in a substantially lofted state in others, even when the mold halves are closed. The compressed laminate 18 comprises the hoodliner H₁. For example, as shown in FIGS. 2C and 3, the lofted areas L of the hoodliner H₁ are only slightly compressed or remain uncompressed or non-compacted at a thickness T₁ (from about 3 mm to about 25 mm and preferably about 8 mm), while the remaining area(s) C are compressed or compacted at a second thickness T₂ (from about 0.5 mm to about 3 mm and preferably about 2 mm). The laminate 18, prior to compression, had a thickness of approximately 30 mm. The compressed areas C structurally enhance the hoodliner H₁, as compacted or compressed areas are generally more rigid than the moderately compressed or lofted areas. The lofted areas L provide the hoodliner with enhanced sound and heat energy absorption capability.

In an alternative embodiment of the present invention, the layers 12, 14 and 16 are laminated together and formed into a hoodliner in the same operation. First, the three layers 12, 14 and 16 are stacked together such that the core layer 12 is positioned between the outer layers 14 and 16. The layers 12, 14 and 16 are then heated in an oven to a temperature of about 350 degrees F., and subsequently placed between the dies 20a and 20b, where the layers 12, 14 and 16 are substantially simultaneously laminated to one another and formed into a hoodliner when the dies 20a and 20b come together.

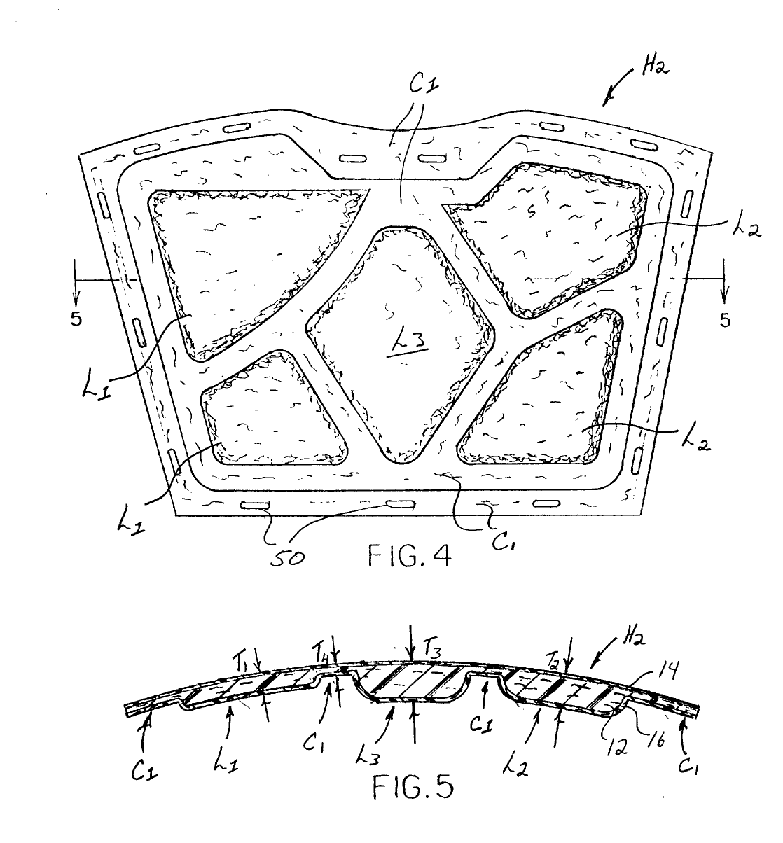

In a second embodiment, illustrated in FIG. 4, a hoodliner H₂ is illustrated having first, second and third lofted areas L₁, L₂, and L₃ and compressed areas C₁. The first lofted areas L₁ have a thickness T₁ of from about 4 mm to about 6 mm, the second lofted areas L₂ have a thickness T₂ of about 8 mm and the third lofted area L₃ has a thickness T₃ of about 10 mm. The compressed areas C₁ have a thickness T₄ of from about 1 mm to about 3 mm. The lofted area L₃ provides a sound and heat energy insulation capability that exceeds that of the lofted areas L₁, and L₂, while lofted areas L₂ provide a sound and heat energy insulation capability that is greater than that provided by lofted areas L₁. Compressed areas C₁ provide structural support to the hoodliner H₂.

By strategically choosing the locations and thicknesses of the lofted and compressed/compacted areas or regions, the sound and heat absorbing capabilities of the liner 10, as well as the particular degree of structural enhancement afforded, may be selectively controlled. For example, in the case of the hoodliner H₂, illustrated in FIG. 4, by positioning the lofted area L₃ in the center portion of the hoodliner H₂, a substantial amount of the sound and heat energy generated by a vehicle engine is absorbed. The remaining lofted areas L₁ and L₂ provide additional acoustic and heat energy insulation capabilities, but also provide some structural support too. The compressed areas C₁ provide the hoodliner H₂ with enhanced structural support. It is noted that the compressed areas C₁ are provided with a plurality of openings 50, through which bolts or other connectors extend so as to couple the hoodliner H₂ to the vehicle hood.

In some cases, the structural enhancement afforded by compressed areas in the hoodliner H₁ or H₂ may reduce the number of integral metal ribs or like structures required in the vehicle hood itself or the thickness of the steel or other metal required in the vehicle hood. This in turn reduces the overall weight of the vehicle hood and hence the manufacturing cost. Where other aspects of the vehicle design so permit, it may even be possible to eliminate the ribs in the vehicle hood entirely, and simply rely on the structural enhancement afforded by the hoodliner.

### EXAMPLES

### Example 1

A hoodliner H₃ was constructed having outer layers 140 and 160 and a core layer 120, as illustrated in FIG. 6. The outer layers 140 and 160 were formed from a non-woven mat, in the manner described above. The mat had a thickness of 5 mm, a density of 1500 g/m², contained PVC/heat stabilizer material in an amount of about 30%, based on the total weight of the mat, and glass fibers in an amount of about 70%, based on the total weight of the mat. The core layer 12 comprised a high-lofted non-woven polyester core (purchased from the Rogers Corporation) having a thickness of about 15 mm, and a density of about 500 grams/m². The pre-molding thickness of the substrate 111 was 25 mm. After compression, a first lofted area L₁ had a thickness of about 8 mm and a second lofted area L₂ had a thickness of about 10 mm.

A standard test procedure (ASTM C384-98) using an impedance tube was used to quantify the acoustical performance of the lofted regions L₁ and L₂. At a 1000 Hz test level, both regions absorbed approximately 60% of the acoustic energy applied to them.

The flexural strength of each outer layer 140 and 160 was approximately 15,000, the tensile strength of each outer layer 140 and 160 was approximately 10,000 psi, and the flexural modulus of each layer was approximately 0.9×10⁶ psi.

### Example 2

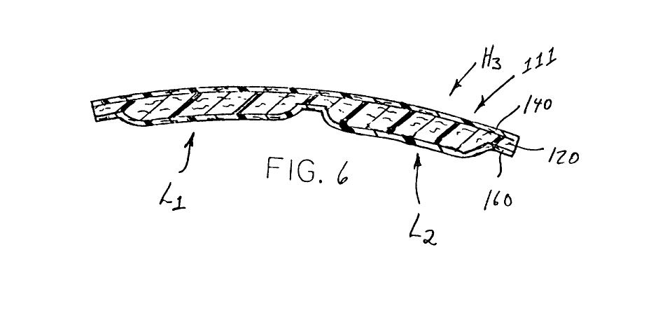

A hoodliner H₂ was constructed having outer layers 14 and 16 and a core layer 12, as illustrated in FIGS. 4 and 5. The outer layers 14 and 16 were formed from a non-woven mat, in the manner described above. The mat had a thickness of 5 mm, a density of 2000 g/m², contained PVC/heat stabilizer material in an amount of about 30%, based on the total weight of the mat, and glass fibers in an amount of about 70%, based on the total weight of the mat. The core layer 12 comprised a polyurethane foam (purchased from Woodbridge Foam Group) having a thickness of about 12 mm, and a density of about 800 grams/m². The pre-molding thickness of the substrate 11 was 22 mm. After compression, a first lofted area L₁ had a thickness of about 8 mm, a second lofted area L₂ had a thickness of about 10 mm, and a third lofted area L₃ had a thickness of about 15 mm.

A standard test procedure (ASTM C384-98) using an impedance tube was used to quantify the acoustical performance of the lofted regions L₁, L₂ and L₃. At a 1000 Hz test level, the first region L₁ absorbed approximately 40% of the acoustic energy applied, the second region L₂ absorbed approximately 55% of the acoustic energy applied, while the third region absorbed approximately 65% of the acoustic energy applied.

The flexural strength of each outer layer 140 and 150 was approximately 20,000, the tensile strength of each outer layer 140 and 160 was approximately 15,000 psi, and flexural modulus of each outer layer 140 and 160 was approximately 1.5×10₆.

The foregoing description of the present invention has been presented for purposes of illustration and description. It is not intended to be exhaustive or to limit the invention to the precise form disclosed. Obvious modifications or variations are possible in light of the above teachings. The embodiments described were chosen to provide a general illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A structurally enhanced liner for selectively insulating against the transmission of sound and heat energy, comprising:
a multi-layer substrate comprising an insulating layer and at least one structural layer, said structural layer comprising a reinforced composite, and said substrate being formed so as to have at least one lofted area for insulating against the transmission of sound and heat energy and at least one compacted area for structurally enhancing the liner.

2. The liner according to claim 1, wherein said substrate comprises first and second structural layers.

3. The liner according to claim 2, wherein at least one of said structural layers is formed from a reinforced composite comprising a non-woven mat including a plurality of chopped fibers and a polymeric material.

4. The liner according to claim 3, wherein said polymeric material comprises a polyvinyl chloride.

5. The liner according to claim 2, wherein the insulating layer comprises at least one of a non-woven fiber insulation layer, a phenolic-bound non-woven glass fiber mat, a polyurethane foam sheet, a needled fiber mat, and a mixture of organic and mineral fibers formed in a lofted and semi-compacted batt.

6. The liner according to claim 5, wherein the non-woven fiber insulation layer comprises a non-woven fabric made from one or more of a polyolefin, polyester, polypropylene, rayon, aramid and cotton.

7. The liner according to claim 2, wherein said substrate has first and second lofted areas, and a first compacted area, said first lofted area having a first thickness of a first dimension, said second lofted area having a second thickness of a second dimension and said compacted area having a third thickness of a third dimension, said second dimension being greater than said first and third dimensions.

8. The liner according to claim 2, wherein said lofted area has a first thickness of a first dimension and said compacted area has a second thickness of a second dimension, said first dimension being substantially equal to about 3 to about 25 times said second dimension.

9. The liner according to claim 2, wherein said substrate comprises a hoodliner.

10. A method of manufacturing a structurally enhanced liner for selectively insulating against the transmission of ambient sound and heat energy, comprising:
forming a multi-layer substrate comprising an insulating layer of material and first and second structural layers, each said structural layer comprising a reinforced composite;
compressing one or more selected regions of the substrate to structurally enhance the liner, while leaving at least one lofted region for insulating against the transmission of sound and heat energy.

11. The method according to claim 10, wherein the step of compressing the one or more selected regions of the substrate includes placing the substrate between a pair of opposing dies that together form a contour corresponding to the desired shape of the liner.

12. The method according to claim 10, wherein the step of forming a multi-layer substrate comprises the steps of:
combining the insulating and first and second structural layers such that the insulating layer is positioned between the first and second structural layers;
heating said combined insulating and structural layers under slight pressure such that said layers laminate to one another to form said substrate.

13. The method according to claim 12, wherein said step of compressing one or more selected regions of the substrate comprises the steps of:
heating the laminated substrate;
placing the heated substrate between a pair of cold dies; and
bringing together the dies so as to compress the one or more selected regions of the substrate.

14. The method according to claim 10, wherein said steps of forming a multi-layer substrate and compressing one or more selected regions of the substrate comprise the steps of:
combining the insulating and first and second structural layers such that the insulating layer is positioned between the first and second structural layers;
heating said combined insulating and structural layers;
placing the heated layers between a pair of cold dies; and
bringing together the dies so as to laminate the layers together to form the substrate while also compressing the one or more selected regions of the substrate.
